(19) United States
(12) Patent Application Publication
(10) Pub. No.: US 2012/0025105 A1
(43) Pub. Date: Feb. 2, 2012

(54) POWER CONCENTRATOR FOR TRANSMUTING ISOTOPES

(75) Inventors: David A. BROWN, Dunrobin (CA); David J. HEPWORTH, Ottawa (CA); Simon J. FORKNALL, Ottawa (CA); Peter W.A. BROWN, Almonte (CA); David M. MACRILLO, Ottawa (CA); Kevin Murray AUSTIN, (US)

(73) Assignee: MEVEX CORPORATION, Stittsville (CA)

(21) Appl. No.: 13/192,061

(22) Filed: Jul. 27, 2011

Related U.S. Application Data
(60) Provisional application No. 61/368,115, filed on Jul. 27, 2010.

(30) Foreign Application Priority Data
Aug. 31, 2010 (CA) 2713972

(51) Int. Cl. G21K 5/10

(52) U.S. Cl. 250/492.3

(57) ABSTRACT

A method of effecting a chemical, physical or transmutational change in a target material using a high power particle beam concentrated on the target material. The particle beam is scanned in a controlled manner to reduce its power density and to avoid damage to equipment which is unable to tolerate high power densities. Movement between the target and the scanned beam is synchronized to cause the scanned beam to persistently or continuously strike the target to effect the chemical, physical or transmutational change, thereby concentrating the beam on the target.

### CROSS-REFERENCE TO RELATED APPLICATIONS

The present application claims the benefit of U.S. Provisional Application No. 61/368,115, filed Jul. 27, 2010, the contents of which are incorporated herein be reference in their entirety.

### FIELD

The present disclosure relates generally to particle accelerators. More particularly, the present disclosure relates to a method and system for applying high power density electron and/or x-ray beams to materials for the purpose of effecting chemical, physical, or nuclear transmutational changes.

### BACKGROUND

In many applications there is a need to focus or concentrate all of a particle beam's energy on target volumes. In other cases only a portion of the total beam energy is useful for effecting the change desired and the remainder is waste. The waste is heat, which can be difficult and expensive to deal with. Disposing of the waste heat can be so difficult or expensive that a particular application may be impractical or impossible.

For example, ⁹⁹Mo, which is the parent of ^{99m}Tc, an isotope widely used for medical diagnostic purposes, can be produced by the photonuclear transmutation of ¹⁰⁰Mo. The process requires Bremsstrahlung to interact with ¹⁰⁰Mo. “Bremsstrahlung” (meaning braking radiation) is the radiation which is emitted when electrons are decelerated or braked when they are fired at a target. Accelerated charges give off electromagnetic radiation, and when the energy of the bombarding electrons is high enough, that radiation is in the x-ray region of the electromagnetic spectrum. Bremsstrahlung is characterized by a continuous distribution of radiation which becomes more intense and shifts toward higher frequencies when the energy of the bombarding electrons is increased. The more intense the Bremsstrahlung, the higher the specific activity of the ⁹⁹Mo (in Curies/gram). To produce Bremsstrahlung of sufficient intensity to create photonuclear transmutation of ¹⁰⁰Mo requires very high electron beam intensity at very high kinetic energy. Providing such a high electron beam intensity at high kinetic energy is readily achievable.

However, while producing a beam of sufficient intensity and energy is readily achievable, the means to deliver the necessary intensity of Bremsstrahlung to a material intended for photonuclear transmutation has not heretofore been practicable. To extract a high energy, high power, and high areal power density electron beam from its acceleration environment (which is high vacuum), through a vacuum barrier, and through atmosphere to a Bremsstrahlung converter suffers several impediments. First, in high power operation, only about half the beam power is converted to useable Bremsstrahlung; the remainder is waste heat. Due to the rate of power absorption in the vacuum barrier and the converter, this waste heat will destroy most practical materials of which the vacuum barrier and the converter can be made.

It is, therefore, desirable to provide an improved means to extract a high power density particle beam from a particle accelerator for application to a material.

### SUMMARY OF THE INVENTION

In a first aspect, there is provided a system for effecting a transmutational change in a target material. The system comprises an electron beam accelerator to provide an electron beam; a scan horn receiving the electron beam, the scan horn including a scanning assembly to cause the electron beam to travel across a window of the scan horn over an arc of travel to provide a scanned beam; a target assembly on which to mount the target material, the target assembly mounted on a translation device to move the target material along a path substantially identical to the arc of travel of the scanned beam; and a controller to synchronize movement of the translation device and the scanned beam to cause the scanned beam to be concentrated on the target material to effect transmutation of the target material.

In a further aspect, there is provided a method of effecting a chemical, physical or transmutational change in a target material. The method comprises providing a concentrated particle beam; scanning the concentrated particle beam to provide a scanned beam; and concentrating the scanned beam on a target by synchronizing movement between the target and the scanned beam to cause the scanned beam to persistently strike the target to effect the chemical, physical or transmutational change of the target.

In yet a further aspect, there is provided a method of transmuting an isotope. The method comprises producing a concentrated electron beam in a vacuum environment; deflecting the electron beam over an arc of travel to provide a scanned electron beam; extracting the scanned electron beam from the vacuum environment; and synchronizing movement of an isotope target and the scanned electron beam, such that the scanned electron beam continuously impinges the isotope target to effect transmutation of the isotope target.

### BRIEF DESCRIPTION OF THE DRAWINGS

Embodiments of the present disclosure will now be described, by way of example only, with reference to the attached Figures, wherein:

FIG. 1 is a side view in cross-section of an embodiment of a system according to the present invention;

FIG. 2 is a side view in cross-section of a further embodiment of a system according to the present invention

FIG. 3 is top view in cross-section of a further embodiment of a system according to the present invention.

### DETAILED DESCRIPTION

The present disclosure describes methods and apparatus which allow concentrated radiation power from a particle accelerator to be spread out over places where it would otherwise cause undesirable effects and to concentrate it where it is intended to cause desirable effects.

The present disclosure generally describes a method of effecting a chemical, physical or transmutational change in a target material using a high power particle beam concentrated on the target material. The particle beam is scanned in a controlled manner to reduce its power density and to avoid damage to equipment which is unable to tolerate high power densities. Movement between the target and the scanned beam is then synchronized to cause the scanned beam to persistently or continuously strike the target to effect the chemical, physical or transmutational change, thereby concentrating the beam on the target.

According to an embodiment, the present disclosure is directed to an apparatus to move a target material in synchronization with the impingement of an electron beam on a Bremsstrahlung converter, so that the material is always exposed to the full intensity of the Bremsstrahlung produced in the converter. The particle beam is a high power, highly concentrated electron beam generated in a vacuum system by, for example, a linear accelerator. The electron beam is scanned across the vacuum barrier (e.g. a titanium window) of a scan horn and then extracted from vacuum system. The scanned beam can then be converted to Bremsstrahlung, such as by striking a tungsten or tungsten carbide plate. The useful portion of the beam (Bremsstrahlung) can then be applied to the final target material by causing the target material to move in synchronization with the electron beam movement on the converter so that the full intensity of the Bremsstrahlung is always concentrated on the intended target material. The target can be controlled to follow the scanned beam, or the scanned beam can be controlled to follow the target.

The present technique can be used to provide a highly concentrated electron or x-ray beam for use in, for example, nuclear transmutation for isotope production, such as medical isotope production; radiochemistry experiments; and materials studies.

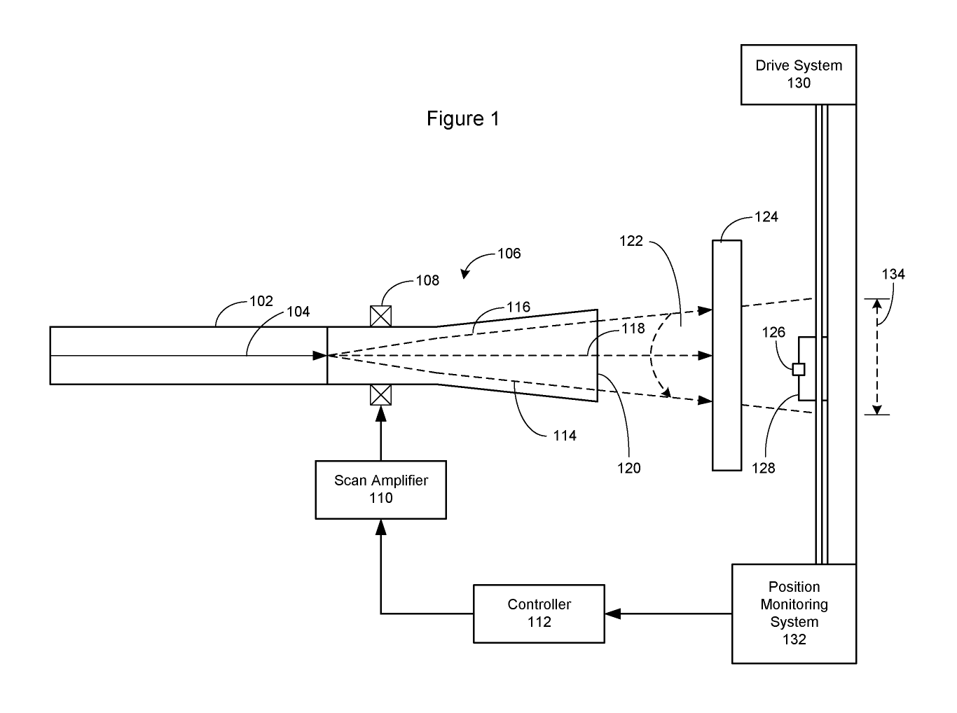

Embodiments of the present system will now be described with reference to FIGS. 1-3. The system is generally designed to synchronize the movement of the target, such as an isotope target, and the electron beam to maximize the exposure of the target to the x-rays produced in the converter. While the embodiments discussed below use a linear particle accelerator, any suitable particle accelerator in which the beam can be steered or scanned can be used, as will be clear to those of skill in the art.

FIG. 1 shows a side view in cross-section of an embodiment of the system where the position of the target controls the scanning of the beam. A conventional particle accelerator 102, such as a linear particle accelerator or linac, which provides, for example, a 20 MeV 20 kW electron beam of less than 10 mm diameter at the electron window, can be used.

The beam of accelerated electrons 104 is received from the accelerator 102 and enters scan horn 106, both of which are under high vacuum. A scanning magnet assembly, comprising electromagnets 108 and a scan amplifier 110 deflects electron beam 104 in an amount proportional to a current through the electromagnets 108. The current is provided by scan amplifier 110, under the control of controller 112, as will be described further below. Path 114 represents a maximum deflection in the lower direction, path 116 represents a maximum deflection in the upper path, and path 118 represents the direction of beam 104 with essentially no current passing through scanning magnet assembly.

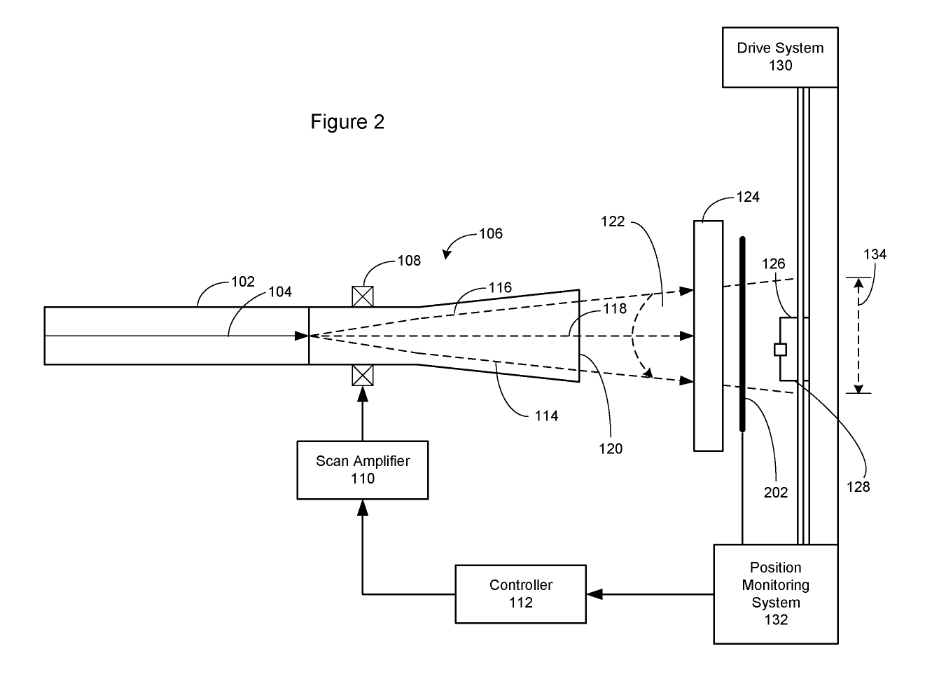

The beam is scanned to ensure the integrity of the titanium window 120, or other vacuum barrier, on the scan horn 106. As will be understood by those of skill in the art, the particular geometry and control of the scanning magnet assembly will determine the scan pattern of the electron beam 102 across the window 120. For the purposes of the present description, the pattern is assumed to be a vertical scanning pattern having an arc of travel from the maximum deflection in the lower direction (path 114) to the maximum deflection in the upper direction (path 116), but any appropriate orientation of scan can be used, as appropriate to a particular application or configuration. A simple control system is shown in FIG. 2, in which a shaft resolver provides a digital signal

In an embodiment, the electrons of the scanned beam 122 exit the scan horn 106 into the atmosphere and strike a converter plate 124, such as a Bremsstrahlung converter, where they are converted to x-ray energy. The typical materials for this conversion plate 124 are dense metals such as tungsten or tantalum, since the conversion efficiency is directly proportional to the atomic number of the conversion material, and the x-ray intensity is a function of the thickness of material that the electrons must pass through.

The x-rays exit the converter plate 124 with essentially the same scan pattern as the scanned beam, and then strike a target assembly comprising a target 126 that is mounted on a target mount 128. The target assembly is mounted on a linear/arc translation device that, in the illustrated embodiment, is comprised of a driveshaft 129 and a drive system 130 that translates the target mount 128 along a path 134 substantially identical to the arc of travel of the scanned beam 122. In a presently preferred embodiment, the linear/arc translation device uses a servo motor to drive the target through a cam system. A position monitoring system 132 is provided to monitor the position of the target assembly. The position monitoring system 132 can include any suitable transducing device(s), such as optical transducers, a driveshaft resolver,s or other suitable optical, rotary, or linear position transducers or encoders as are well known in the art.

As will be understood by those of skill in the art, passage of the scanned beam 122 through the atmosphere defocuses the beam. Similarly, the x-rays exiting the converter plate 124 will also be somewhat defocused, and will assume a generally conical shape. To refocus, or concentrate the beam on to the target 126, movement of the scanned beam 22 and the target 126 are synchronized. Generally, the magnetic scanning system, including scan magnets 108 and scan amplifier 110, can be driven by the position monitoring system 132 monitoring the position of the target mounted on the linear/arc translation device.

The position monitoring system 132 senses the position of the target assembly. The sensed position is provided to the controller 112, which, in turn, controls the scan amplifier 110 of the scanning magnet assembly to ensure that the position of the beam and the position of the target 126 coincide. The controller 112 can be a general purpose computer or a digital signal processor, or other suitable controller depending on the particular choice and configuration of the position monitoring system 132, the scan amplifier 110, and optionally the drive system 130. For example, according to an embodiment, a shaft resolver/encoder can be shaft-mounted behind the servo motor which drives the target assembly. The target assembly position can be determined accurately by reading position data from the shaft resolver and driving the scan amplifier 110 accordingly, such as through a variable analog voltage, provided by a digital/analog converter, which drives the electron beam in synchronization with the movement of the target.

FIG. 2 shows a side view in cross-section of an embodiment of a system according to the present invention where the scanning of the beam controls the position of the target. The details of the components, which are substantially identical to those of FIG. 1 will not be repeated. The difference in the system of FIG. 2 is that the linear/arc translation device (through the drive system 130) is driven synchronously with the scanning of the beam, as opposed to driving the beam in synchronization with the target assembly position. In this embodiment, the position of the beam is monitored by a beam position monitor 202. The controller 112 then uses the beam position to control the speed of the drive system 130, such as by changing the drive frequency setpoint for the servo motor described above.

In a further embodiment (not shown), the angle of the target assembly can be controlled in relation to the translation device to maintain the target material at an angle such that it continuously faces the beam centerline. For example, the target assembly can be mounted on a mechanical control arm, under servo control, that can adjust the angle of the target assembly based on its position along the path 134.

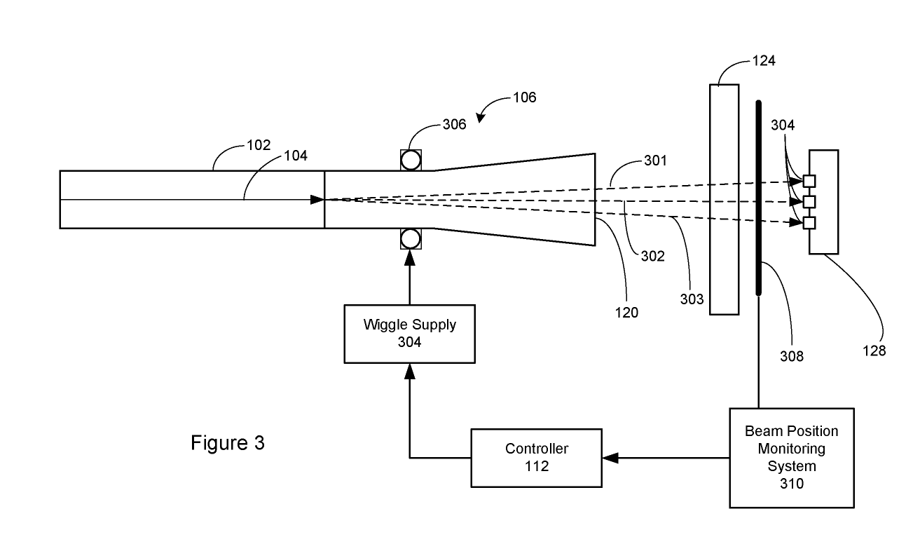

FIG. 3 shows a top view in cross-section of a system according to a further embodiment, where, in addition to scanning the beam vertically using the scanning magnet assembly, the beam is also “wiggled” or translated laterally in a stepwise manner (as shown by the paths 301, 302 and 303, thereby permitting multiple targets 304 to be irradiated. This lateral translation can be achieved using “wiggle” magnets 306, acting perpendicular to the magnets 108 (not shown—see FIG. 2), a wiggle supply 308 to control current to the magnets 306 and a beam position monitor 308 and beam position monitoring system 310 to monitor the lateral position of the scanned beam.

It is also contemplated that a single accelerator can be used to provide electron beam power to multiple target stations, in one or more rooms containing scanning equipment and a target translation device. Multiple target stations would allow continuous accelerator operation and finished target handling at stations other than the currently operating station. Suitable magnetic containment, redirection and kicker systems can be provided to guide the electron beam to appropriate stations or rooms.

The present invention allows for a very high average power electron beam to traverse the vacuum barrier and produce Bremsstrahlung for beneficial purposes, such as chemical, physical or transmutational change, without compromising the integrity of the vacuum barrier or the converter. There are many possible uses for the apparatus and method described herein. For example, the method and system can be used to irradiate ¹⁰⁰Mo by Bremsstrahlung to transmutate it into ⁹⁹Mo, which is the decay parent of ^{99m}Tc, a useful and widely used medical diagnostic imaging isotope. The photonuclear transmutation of ¹³⁴Xe into ¹³¹I, and the conversion of ¹⁸⁶W to ¹⁸⁷Re by the same method are also example uses. Many other photonuclear transmutations are known, and the present invention can be extended to use in any of these applications with suitable modifications, as will be apparent to anyone of skill in the art.

As will be appreciated by those of skill in the art, the present invention has many advantages over the prior art. The method and apparatus provide a means to concentrate an electron beam directly on a target achieving very high power areal density. This present invention provides a means to alleviate the limitations of the prior art by distributing the average electron beam power over a much larger area of the vacuum barrier and the converter thereby reducing the areal power density on both. Consequently the thermal stresses in both are reduced below the threshold of destruction.

In particular, the method and apparatus provide a means to concentrate high power, high intensity Bremsstrahlung on at least one target material while diverting unwanted heat from the target material. The apparatus permits the use of conventional vacuum barriers, while protecting the barrier from thermal damage. Similarly, simply cooled Bremsstrahlung converters can be used. The target material is also protected from damage due to unwanted impingement of high power, high intensity electron beams. By controlling the scanning of the beam and/or the movement of the target material, the target material can also be irradiated from a variety of directions.

The present invention permits more than one target to receive the desired Bremsstrahlung. It also provides a means to avoid use of exotic Bremsstrahlung converter materials. It also avoids location of a Bremsstrahlung converter inside the acceleration vacuum envelope. It also avoids the use of a Bremsstrahlung converter as the vacuum barrier.

The above-described embodiments are intended to be examples only. Alterations, modifications and variations can be effected to the particular embodiments by those of skill in the art without departing from the scope, which is defined solely by the claims appended hereto.

What is claimed is:

1. A system for effecting a transmutational change in a target material, comprising:
an electron beam accelerator to provide an electron beam;
a scan horn receiving the electron beam, the scan horn including a scanning assembly to cause the electron beam to travel across a window of the scan horn over an arc of travel to provide a scanned beam;
a target assembly on which to mount the target material, the target assembly mounted on a translation device to move the target material along a path substantially identical to the arc of travel of the scanned beam; and
a controller to synchronize movement of the translation device and the scanned beam to cause the scanned beam to be concentrated on the target material to effect transmutation of the target material.

2. The system of claim 1, wherein the scanning assembly is a magnetic scanning assembly.

3. The system of claim 1, further comprising a Bremsstrahlung converter interposed between the scanned beam and the target material.

4. The system of claim 2, further comprising:
a drive system to drive the target assembly over the path equivalent to the arc of travel of the scanned beam; and
wherein the controller controls the drive system to synchronize movement between the target assembly and the scanned beam.

5. The system of claim 4, wherein the target assembly includes an attitude control assembly to maintain a substantially constant angle between a target face of the target material and a centerline of the scanned beam.

6. The system of claim 1, wherein the controller synchronizes movement of the target assembly to the scanned beam.

7. The system of claim 1, wherein the controller synchronizes movement of the scanned beam to the target assembly.

8. The system of claim 4, wherein the target assembly holds a plurality of targets arranged substantially perpendicular to the arc of travel of the scanned beam, and wherein the system further comprises a beam shifting assembly to shift the electron beam across each of the plurality of targets in a direction substantially perpendicular to a path of each individual target.

9. The system of claim 8, wherein the beam shifting assembly is provided by magnets acting perpendicular to magnets of the magnetic scanning assembly.

10. A method of transmuting an isotope, comprising:
producing a concentrated electron beam in a vacuum environment;
deflecting the electron beam over an arc of travel to provide a scanned electron beam;
extracting the scanned electron beam from the vacuum environment; and
synchronizing movement of an isotope target and the scanned electron beam, such that the scanned electron beam continuously impinges the isotope target to effect transmutation of the isotope target.

11. The method of claim 10, further comprising converting the scanned electron beam to an x-ray beam prior to impinging the isotope target.

12. The method of claim 10, further comprising converting the scanned electron beam to Bremsstrahlung radiation prior to impinging the isotope target.

13. The method of claim 10, wherein the isotope target is ¹⁰⁰Mo, ₁₃₄Xe or ¹⁸⁶W.

14. A method of effecting a chemical, physical or transmutational change in a target material, comprising:
providing a concentrated particle beam;
scanning the concentrated particle beam to provide a scanned beam; and
concentrating the scanned beam on a target by synchronizing movement between the target and the scanned beam to cause the scanned beam to persistently strike the target to effect the chemical, physical or transmutational change of the target.

15. The method of claim 14, wherein the particle beam is an electron beam.

16. The method of claim 15, further comprising converting the beam to Bremsstrahlung radiation prior to striking the target.

17. The method of claim 15, further comprising producing the electron beam in a vacuum system, and extracting the beam from the vacuum system.

18. The method of claim 10, wherein the target material is ¹⁰⁰Mo, ₁₃₄Xe or ¹⁸⁶W.
